(19) United States
(12) Patent Application Publication
(10) Pub. No.: US 2002/0112328 A1
(43) Pub. Date: Aug. 22, 2002

(54) Shur-lock snap

(76) Inventor: Daniel Edward Strome, London (CA)

Correspondence Address: Daniel Edward Strome, 302-650 Cheapside St., London, ON, N5Y 5G8, CA

(21) Appl. No.: 09/788,431

(22) Filed: Feb. 21, 2001

(51) Int. Cl. F16B 45/00

(52) U.S. Cl. 24/698.3

(57) ABSTRACT

The shur-lock snap for easier and faster method of connecting tackle products to and from the fishing line, a straight arm connecting to a proximate arm, the proximate arm furthermore connected to an opposite arm where the distal end of the opposite arm is at least once wrapped loosely indirectly surrounding the straight arm. The lure is slid over the open end of the opposite arm down the wound wire eventually resting on the proximate arm.

### BACKGROUND OF THE INVENTION

The invention relates to fishing line tackle. Particularly, the invention relates to a snap which provides an easier engagement means between the fishing lure to the fishing line. Under the Heading Description of prior art no snap was uncovered which didn't require the hand squeezing motion of pressing the opposite arms together.

With the present day fishing snaps that are available, you must squeeze or press the opposite arms together in order to unfree one arm from the opposite arm for the purpose of placing the lure, hooks and swivel into the snap. With present day snaps you must also squeeze or press the opposite arms together in order to close the fishing snap, therefore locking the fishing tackle inside the snap.

The present invention will now be described as a snap which doesn't require the hand motion of opening and closing of the snap. It will be understood that with this snap you simply position the aperture of the tackle product over the end of opposite arm of the shur-lock snap, and twist the tackle product around the loosely wound wire until it falls into the closed loop segment.

### SUMMARY OF THE INVENTION

It is the object of the invention to provide an easier and faster method of connecting the fishing lure to the line, besides the method of directly tying the line to the lure. Other objects, advantages and features will be apparent from the following more detailed description, thereof taken in connection with the accompanying drawing.

The present invention will be summarized as a fishing snap for an easier connection means between the fishing line to the fishing lure. The snap includes a formed loop segment defining a free aperture, the straight segment extends to a proximate arm and further connecting to one opposite arm. Towards the distal end of the opposite arm, the wire is loosely wound around the straight arm to form a loosely wound pigtail. Swivels are inter-changeable with the straight arm having a loop segment and returning to be loosely wound around the edges of the straight arm for the purpose of interchanging swivels.

### BRIEF DESCRIPTION AND SEVERAL VIEWS

The invention will now be described by way of example and references to the accompanying drawing in which:

FIG. 1 is a view of the snap indicating the opposite arm wound around the straight arm.

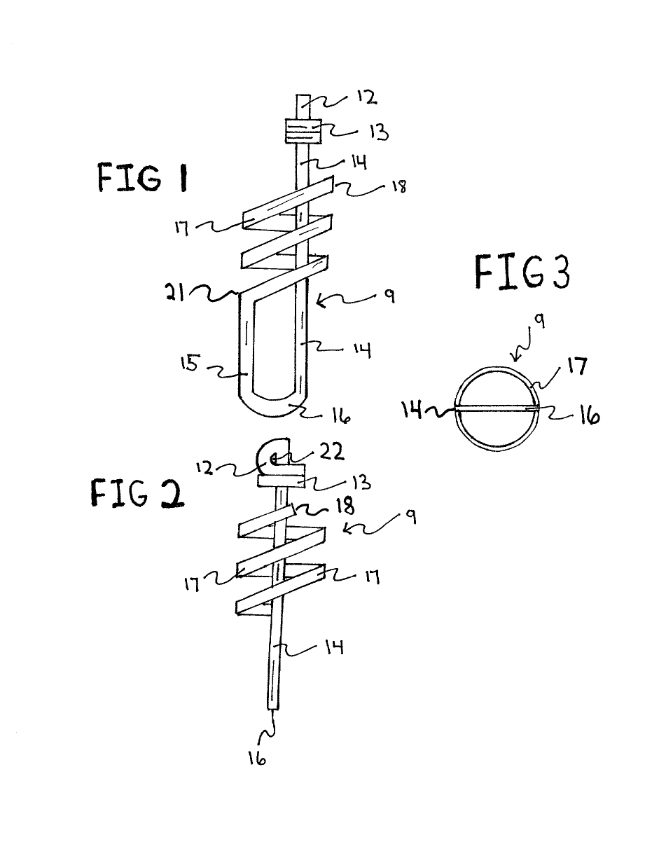

FIG. 2 is a side view illustrating the fastening means of the fishing line according to my invention.

FIG. 3 is an end view of the snap according to my invention.

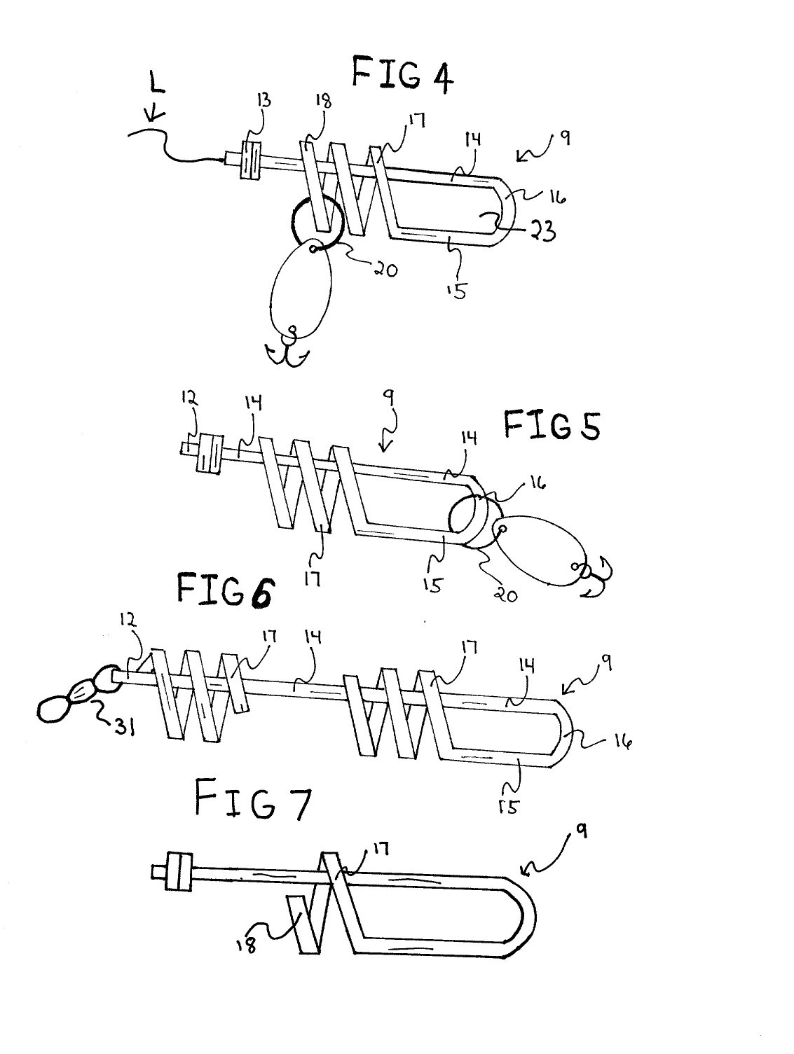

FIG. 4 is a schematic diagram of the lure being slid onto the open end of the wound wire.

FIG. 5 is a perspective view of the lure positioned onto the loop segment of the snap.

FIG. 6 is a top view of the snap having the wire loosely wound around the said straight arm.

FIG. 7 is a view of the snap with the wire once loosely wound around the straight arm.

### DESCRIPTION OF THE PREFERRED EMBODIMENT

Referring to the drawing, FIG. 1, the shur-lock snap is generally indicated as (9), the lure or hook generally as (H) and the fishing line as (L). With reference to FIG. 1, the sher-lock snap (9) consisting of shaped wire preferably hardened or an unoxidizeable metal such as stainless steel generally formed in the shape of the letter U with opposite arms (14) and (15) interconnected by a proximate arm (16). The straight arm (14) begins at the eyelet (12) with a tightly wrapped pigtail (13). In FIG. 1, the arm (14) extends to a bend in the proximate arm (16), furthermore the arm (16) extends to the opposite arm (15) where it further extends to the bend (21) where it is the beginning of the wire wrapped in a coil form (17). The wire (17) is loosely wrapped around the straight arm segment (14) and stops before the pigtail (13) as shown in FIG. 1 and 2.

Turning to FIG. 2, the side view of the snap (9) indicating the positioning of the eyelet (22) in comparison to the end (18) of the spiral wire (17). The lure (H) is slid over the end of the wire (18), continuing to slide on the spiral wire (17) as shown in FIG. 4, until the lure (H) reaches the proximate arm (16) as showing in FIG. 5 with the lure (H) being trapped inside the loop segment (23) in FIG. 4. In FIG. 2 the loop segment (12) creates an aperture (22), furthermore extending to form a pigtail (13) for the fastening means of the fishing line (L) as shown in FIG. 4.

FIG. 3 depicts an end view of the shur-lock snap (9) showing the wound wire (17) in a circular shape from the proximate arm (16) to the opposite arm (14) which the next ends to loosely wound around the straight arm.

In FIG. 4 the snap (9) having the fishing line (L) fastened to the pigtail (13), showing the straight segment (14) connecting to the proximate arm (16). The end of the loosely wound wire (18) in FIG. 4 is the starting point where sliding the aperture in the lure (H) over the open end (18) of the opposite arm (15) and with a twisting motion the lure (H) slides around the loosely wound wire (17) where eventually the lure (H) falls into the free aperture (23) as shown in FIG. 4 with the lure (H) resting on the proximate arm (16).

In FIG. 5 the lure (H) is twisted in a circular motion sliding down the wound wire (17) until it reaches the proximate arm (16). In order to remove the lure (H) from the snap (9) you simply twist the lure (H) on the opposite arm (15) towards the pigtail (13) until it reaches the end (18) of the opposite arm (15) as indicated in FIG. 4.

FIG. 6 indicates the shur-lock snap (9) having the loosely wound wire (17) at both ends of the snap (9) for the purpose of interchanging lures and swivels. The swivel (31) in FIG. 6 is placed over the end of the wire (19) and slid on the wound wire (17) until it reaches the aperture (22) in FIG. 2. This allows anglers to interchange the swivel (31) on the shur-lock snap (9).

FIG. 7 indicates the shur-lock snap (9) with wire (17) being once loosely wrapped around the straight arm.

What I claim as my invention:

1. The shur-lock snap for releasing attachment of the fishing line to fishing tackle products, this being part of the fishing tackle system, the shur-lock snap doesn't require the hand opening and closing of the snap, the snap comprises:
a straight arm extending to a formed segment defining a free aperture, the loop segment extending to at least one opposite arm, the said opposite arm further extends connecting to the said straight arm forming a permanently closed loop segment, the opposite arm is at least once loosely bent extending indirectly surrounding the outside edge of the straight arm forming a permanently close loop segment;
the said straight arm connecting to at least one opposite arm, the opposite arm is at least once loosely bent extending indirectly surrounding the outside edge of the straight arm forming a permanently closed loop segment with the straight arm connected to a lure for the purpose of interchanging lures. The said opposite end of the straight arm forming a loop segment, furthermore extending to be loosely wound indirectly surrounding the outside edge of the straight arm forming a closed loop segment, the end opposite of the closed loop segment is for connection to the fishing line, lures and swivels.
The end of the said opposite arm is for placing the lure or swivel over at least one unfree arm allowing the said products to slide down the winding arm until they fall into the closed loop segment;

2. The said ends of the opposite arms are wound indirectly surrounding the outside edge of the said straight arm, touching the said straight arm to prevent the lure or swivel from sliding off the end of the said opposite arm.

3. The said opposite arm can be loosely wound surrounding the outside edge of the straight arm, at either end of the said snap.

4. The said opposite arm can be loosely wound indirectly surrounding the outside edge of the straight arm, the opposite end of the straight arm being thread like for a screw like connection to the fishing lure.

5. The said opposite arm can be bent loosely indirectly surrounding the outside edge of the straight arm, the opposite end of the straight arm is connected to a fishing lure.
